(19) United States
(12) Patent Application Publication
(10) Pub. No.: US 2009/0234902 A1
(43) Pub. Date: Sep. 17, 2009

(54) SYSTEM, METHOD AND APPARATUS FOR MAKING CONTENT AVAILABLE OVER MULTIPLE DEVICES

(76) Inventor: Erez PILOSOF, Ramat Hasharon (IL)

Correspondence Address: Pearl Cohen Zedek Latzer, LLP, 1500 Broadway, 12th Floor, New York, NY, 10036, US

(21) Appl. No.: 12/045,891

(22) Filed: Mar. 11, 2008

(51) Int. Cl. G06F 15/16

(52) U.S. Cl. 709/201

(57) ABSTRACT

Embodiments of the invention may enable defining and sharing content spaces. According to embodiments of the invention, metadata may be associated with content and may further be distributed to a number of devices. According to embodiments of the invention, metadata may be used to provide a view of a content space on a plurality of devices. Other embodiments are described and claimed.

### BACKGROUND OF THE INVENTION

Advancements in technology such as computing and networking enables users to store, use, consume, share and/or otherwise manipulate very large amounts of digital information and content. A typical user may store, own or posses thousands of information and/or content objects. Such information and content objects may be stored on a number of storage devices, making the content and information device centric. For example, a user may store some of his pictures on a first storage device such as a home computer, and other pictures on a portable device such as a mobile phone. Under such a scenario, locating stored pictures may comprise checking a number of possible storage devices, or alternatively remembering the storage device associated with each specific picture. Locating content may further comprise physically interacting with a storage device. The above example may apply to any digital content such as, but not limited to, music, multimedia content, mail and/or personal content such as a calendar or an address book.

There is a need for a system and/or method for conveniently managing a user's entire content space from any of a number of applicable device associated with the user.

### SUMMARY OF EMBODIMENTS OF THE INVENTION

Embodiments of the invention may enable defining and sharing of content spaces. According to embodiments of the invention, metadata may be associated with content and may further be distributed to a number of devices associated with a user. According to embodiments of the invention, metadata may be used to provide a view of a content space on a plurality of devices.

### BRIEF DESCRIPTION OF THE DRAWINGS

To embodiments of the invention are illustrated by way of example and not limitation in the figures of the accompanying drawings, in which like reference numerals indicate corresponding, analogous or similar elements, and in which:

FIG. 1 shows an exemplary high-level diagram of an exemplary system according to embodiments of the present invention;

FIG. 2 shows an exemplary high-level diagram of exemplary components according to embodiments of the present invention;

FIG. 3A shows an exemplary high-level diagram of exemplary components according to embodiments of the present invention;

FIG. 3B shows an exemplary high-level diagram of exemplary components according to embodiments of the present invention; and

FIG. 4 shows an exemplary high-level diagram of exemplary components according to embodiments of the present invention;

FIG. 5 shows an exemplary high-level diagram of exemplary components according to embodiments of the present invention; and

FIG. 6 shows an exemplary high-level diagram of exemplary components according to embodiments of the present invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Unless explicitly stated, the method according to embodiments described herein are not constrained to a particular order or sequence. Additionally, some of the described method to embodiments or elements thereof can occur or be performed at the same point in time.

The term “content space” used in this patent application specification should be expansively and broadly construed to include any, possible logical space, where such space may logically or otherwise include or contain any digital information or content or any representation of any digital content or information. For example, a content space may include all digital information or content belonging to, or associated with a specific user or organization. A content space may be defined according to a number of parameters. For example, a content space may be defined according to a user as described above or it may be defined according to a content type further associated with a specific user. For example, a content space may include all electronic mail messages associated with a specific user or a specific sender. Any other applicable parameters may be used in order to define a content space, such parameters may pertain to aspects such as, but not limited to, time and/or date, location, language, content type or any applicable aspects pertaining to an environment, circumstances, devices, users or attributes of content and/or information. One or more content sub-spaces may be created based on filtering content items in a content space based on such parameters as described above.

The term “storage device” used in this patent application specification should be expansively and broadly construed to include any applicable storage device such as, but not limited to, an internal or external hard drive, a random access memory (RAM), a dynamic RAM (DRAM), an erasable programmable read-only memory (EPROM), an electrically erasable programmable read-only memory (E²PROM) storage chip, a removable media, a universal serial bus (USB) device, a network storage device, an optical storage device, a FLASH storage device, a backup storage device or any other device that may be operatively connected to a computing device.

The term “computing device” used in this patent application specification should be expansively and broadly construed to include any applicable computing device that may be or may include a plurality of central processing units (CPU) or any other suitable multi-purpose or specific processors or controllers, a plurality of input units, a plurality of output units, a plurality of memory units, and a plurality of storage units. A computing device may additionally comprise or include other suitable hardware, firmware and/or software components. In some embodiments, a computing device may include or may be, for example, a personal computer, a desktop computer, a mobile computer, a laptop computer, a notebook computer, a terminal, a workstation, a server computer, music player, a personal digital assistant (PDA) device, a tablet computer, a network device, a storage device, a mobile phone, a household appliance or any other suitable computing device with which a user may possibly interact.

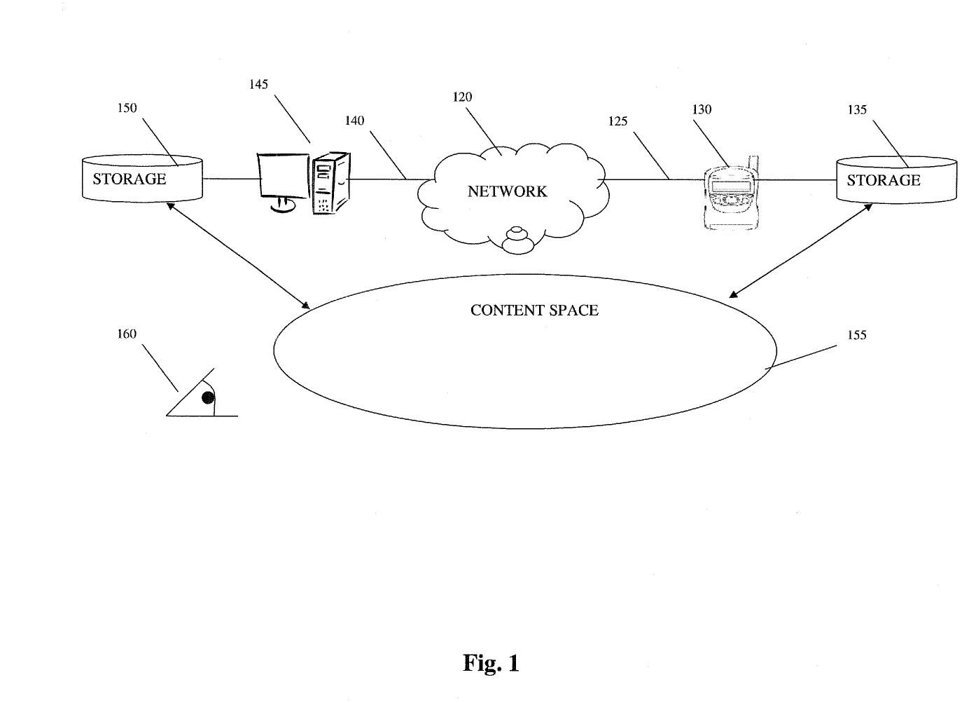

Reference is made to FIG. 1 showing a schematic high level diagram of exemplary components according to embodiments of the invention. According to embodiments of the invention, computing devices 130 and 145 may be computing devices as described above. For example, computing device 130 may be a personal computer and computing device 145 may be a portable, hand held computing device such as a personal digital assistant (PDA) or a mobile phone. It will be recognized that although only two exemplary computing devices are shown in FIG. 1, embodiments of the invention may comprise many such similar or other devices.

According to embodiments of the invention, communication mediums 125 and 140 may respectively connect devices 130 and 145 to network 120. According to embodiments of the invention, communication mediums 125 and 140 may be any suitable communication mediums. For example, communication mediums 125 and 140 may be or comprise a wireless communication medium and/or protocol such as, for example, IEEE 802.11x protocol, IEEE 802.16 protocol, Bluetooth™, IEEE 802.15.4 (also known as ZigBee™), a proprietary radio frequency (RF) protocol, a wireless fidelity (WiFi) communication infrastructure or they may be or comprise an infra red communication infrastructure, e.g., infrared data association (IrDA). According to embodiments of the invention, communication mediums 125 and 140 may alternatively or additionally be or may comprise a wired communication medium such as serial, parallel, twisted pair, coaxial, or any other suitable communication medium, for example, communicating over a protocol such as IEEE 802.3.

According to embodiments of the invention, network 120 may be a private internet protocol (IP) network, a public IP network such as the internet. According to embodiments of the invention, network 120 may further comprise integrated services digital network (ISDN) lines, frame relay connections, and/or network 120 may comprise a modem connected to a phone line or any other suitable communication means. Network 120 may further be or comprise a public switched telephone network (PSTN), any public or private data network, a local area network (LAN), a metropolitan area network (MAN), a wide area network (WAN), a wireline or wireless network, a local, regional, or global communication network, an enterprise intranet or any combination of the preceding capable of enabling devices such as devices 130 and 145 to communicate.

According to embodiments of the invention, storage devices 135 and 155 may be any suitable storage device as described above that may be operatively connected to computing device 130 or device 145. According to embodiments of the invention, storage devices 135 and 155 may be respectively connected to computing devices 130 and 145 by any applicable means.

According to embodiments of the invention, content space 155 may be a logical space logically including or associated with content and/or information objects that may be physically stored on a plurality of storage devices associated with respective computing devices, for example on device 130, e.g., on storage device 135 and/or on device 145, e.g., on storage device 150. Alternatively, according to embodiments of the invention, an information or content object included in content space 155 may be stored on more than one device. For example, possibly identical, copies of a specific content object logically included in content space 155 may be stored on storage device 135 and on storage device 150. However, as described below, identical content objects need only be displayed once in the content space displayed to the user.

According to embodiments of the invention, user 160 may view content space 155 on any computing device. According to embodiments of the invention, content space 155 may be viewed utilizing any properly configured and/or properly equipped device having a display. For example, user 160 may view content space 155 utilizing computing device 130 or utilizing device 145. According to embodiments of the invention, any properly configured device comprising suitable means such as a display may enable a user to view a content space. It should be noted that according to embodiments of the invention, content visibility through a content space does not necessarily imply that visible content is always stored at the computing device on which the content space is viewed or that visible content may be readily consumed. For example, a specific content object stored on storage device 150 may be added to content space 155, possibly by utilizing computing device 145. Accordingly, such content object may be visible by viewing content space 155 where such viewing may be performed utilizing computing device 130. According to embodiments of the invention, consumption of such content object may further require communicating the content object from storage device 150 to the device used for the consumption, e.g., computing device 130, for example, after providing the content metadata and receiving a request for the content. It will be recognized that the request for one or more content objects may be received by a user-generated request at the local computing device, or it may be generated automatically, for example, based on an API, or based on various weights or scores, as described below.

According to embodiments of the invention, adding a content or information object to a content space may comprise creating a metadata object and further associating such metadata object with a content or information object. Such metadata object may be populated with information and/or parameters that may reflect various aspects pertaining to the relevant or associated content object. For example, a metadata object associated with a content object may comprise or include information and/or parameters such as, but not limited to, an icon representing the content object (e.g., a thumbnail image), object size, object type, popularity (e.g., number of times retrieved, viewed or otherwise consumed), time parameters such as date and time of creation of the object, date and time of a last modification of the object, date last viewed and/or other time related aspects pertaining to the object. Other parameters or information comprised or included in a metadata object may be an association of the object with a favorites list or any other, possibly user defined, list, or a marking of the content object, for example by associating it with a virtual star, possibly denoting it as one of special interest. Other parameters or information that may be included in a metadata object such as information indicating whether the object is new or whether the content object is to be shared, and with whom, as described further below.

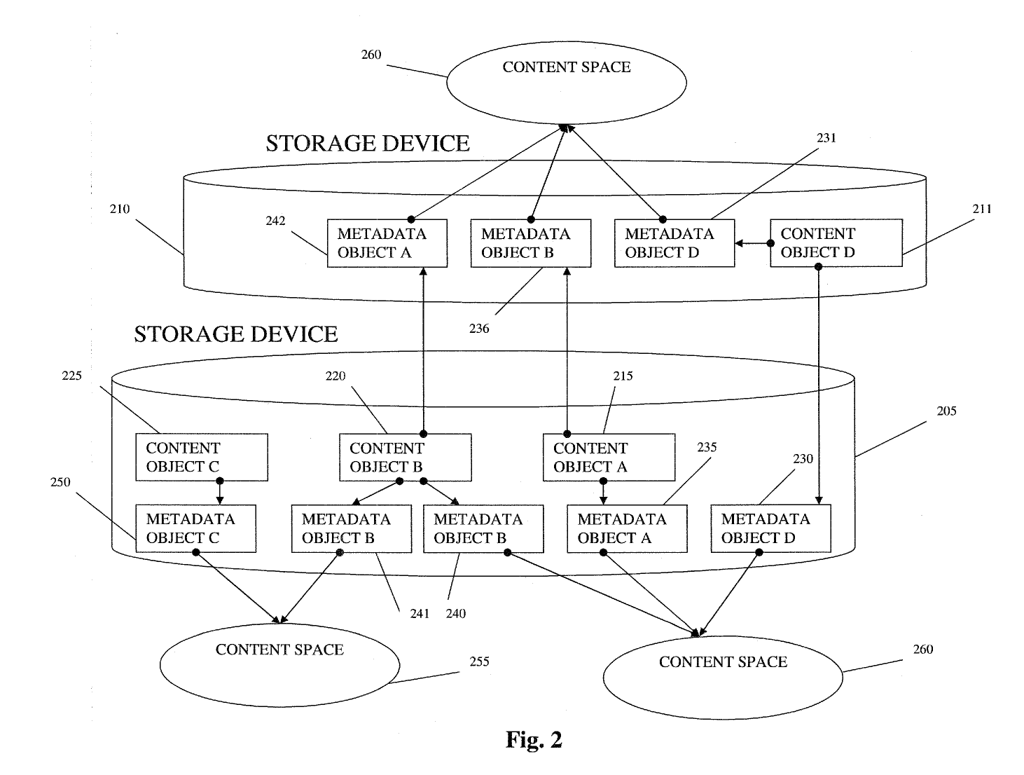

Reference is made to FIG. 2 showing a schematic high level diagram of exemplary components according to embodiments of the invention. According to embodiments of the invention, storage device 205 may be connected or otherwise associated with a first computing device (not shown) and storage device 210 may be connected or otherwise associated with a second, possibly geographically distant, computing device (not shown).

According to embodiments of the invention, storage devices 210 and 205 may be any storage device as described above, for example, with reference to FIG. 1. According to embodiments of the invention, the computing devices (not shown) associated with storage devices 205 and 210 may be computing devices as described above and may further be able and/or configured to communicate or otherwise interact over a communication medium such as network 120 described with reference to FIG. 1. According to embodiments of the invention, content objects 211, 215, 220 and 225 may be any content or information objects such as documents (e.g., spreadsheet, word processor documents, PDF files, etc.), images, multimedia content (e.g., audio and/or video files), or any other digital information or content that may be stored on a storage device.

According to embodiments of the invention, a number of metadata objects may be associated with a single content or information object. For example, as shown in FIG. 2, metadata objects 231 and 230 may be associated with content object 211 and metadata objects 240, 241 and 242 may be associated with content object 220. According to embodiments of the invention, the scope of a content space may be defined by the content objects included by the content space. For example, the scope of content space 255 may be defined as a space comprising or including content objects 220 and 225. Likewise, the scope of content space 260 may be defined as a space comprising or including content objects 220, 215 and 211. According to embodiments of the invention, a content space may be visible, interacted with, or otherwise manipulated from a computing device through metadata objects associated with content objects included in such content space. Accordingly, a content space may be visible from a computing device even if not all content objects included in such content space are stored on the computing device. For example, content space 260 may include content object 211, although content object 211 is not stored on storage device 205, content space 260 may still be visible or interacted with from the computing device associated with storage device 260.

According to embodiments of the invention, a number of content spaces may include or be otherwise associated with a single content object. For example, content spaces 255 and 260 may both include, or be associated with, content object 220. According to embodiments of the invention, a visibility of a content space may be enabled by metadata objects associated with content objects. For example, content object 220 may be visible within content space 255 through and/or by metadata object 241. Content object 220 may further be visible within content space 260 by utilizing metadata object 240. As shown, metadata object 250 may be associated with content object 225 and metadata objects 235 and 236 may be associated with content object 215.

It should be noted that although metadata object 241 and metadata 240 may be associated with the same content object they may, according to some to embodiments of the invention, be separate and possibly different entities. For example, two members of a family may share a personal computer. According to embodiments of the invention, two content spaces may be defined and created for such two users. According to embodiments of the invention, such two content spaces may overlap. According to embodiments of the invention, a number of content spaces may share one or more content objects. In the example above, the two content spaces (e.g., 255 and 260) may each include some common, either locally or remotely stored, content objects. For example, the two content spaces may both include the same family pictures, and/or a number of moving picture experts group (MPEG) objects, also known as “MPEG Layer-3” or simply MP3 music files.

According to embodiments of the invention, a metadata object may be created and associated with a content object for each content space including or comprising such content object, for example, if a content object is included or otherwise associated with three different content spaces then three metadata objects may be created and further each associated with their respective content space and with the content object. Such architecture may enable users to view, manipulate and/or otherwise affect their respective content spaces without interfering with, or otherwise affecting other content spaces even when some content objects are common to such content spaces. For example, in the example above, a first one of the two users may mark a specific picture as one of his favorites. Such marking, according to embodiments of the invention, may be reflected in the metadata object associated with the specific picture and further associated with the respective content space. Accordingly, such marking may have no effect on the content space of the second user since the content space of the second user may be viewed or otherwise manipulated utilizing a different metadata object.

According to embodiments of the invention, a content space may include content objects stored on a number of storage devices, where such storage devices may be of different types and/or they may be associated or otherwise connected to different computing devices and/or may further be geographically distant. According to embodiments of the invention, a metadata object may be stored on a first storage device and may further be associated with a content object stored on a second, possibly remote, storage device. For example, metadata object 230 stored on storage device 205 may be associated with content object 211 stored on storage device 210 and metadata objects 236 and 242 may be associated with content objects 215 and 220 respectively as shown. For example, a user may own or be otherwise associated with a number of computing devices, e.g., a laptop computer, a possibly stationary personal computer and an MP3 music player. According to embodiments of the invention, such user may define a content space comprising or including some content objects stored on the laptop, other content objects stored on the MP3 player and additional content objects stored on the personal computer. According to embodiments of the invention, metadata objects representing or otherwise associated with content objects contained or other wise associated with such defined content space may be distributed to any device. For example, in the example above, metadata objects representing objects included or otherwise associated with the content space may be distributed to and stored on the laptop, MP3 player and the personal computer.

According to embodiments of the invention, such distribution may enable the user to view his content space from any of the devices, e.g., the MP3, laptop or personal computer. For example, content space 260 may be visible or otherwise interacted with from the computing device associated with storage device 210 and/or from the computing device associated with storage device 205. As shown, content space 206 may be visible and/or interacted with on a first computing device associated with storage device 205 by utilizing metadata objects 230, 235 and 240. Content space 260 may alternatively be visible and/or interacted with on a second computing device associated with storage device 210 by utilizing metadata objects 231, 236 and 242.

According to embodiments of the invention, coherency and/or consistency of aspects pertaining to a content space may be preserved and/or maintained across or between a number of devices. For example, if a metadata object such as metadata object 235 is modified then a corresponding metadata object, e.g., metadata objects 236 may be updated or modified in order to reflect the change or modification applied to metadata object 235. Accordingly, the same content space view (e.g., content space 260) may provided on any device configured to provide such view. For example, adding content object 211 to a favorites list may be reflected in metadata object 231. According to embodiments of the invention, metadata object 230 may also be updated, or possibly replaced in order to reflect the addition of content object 211 to a favorites list. Accordingly, content object 211 may appear in the favorite list when content space 260 is viewed utilizing either metadata objects stored on storage device 210 or metadata objects stored on storage device 205.

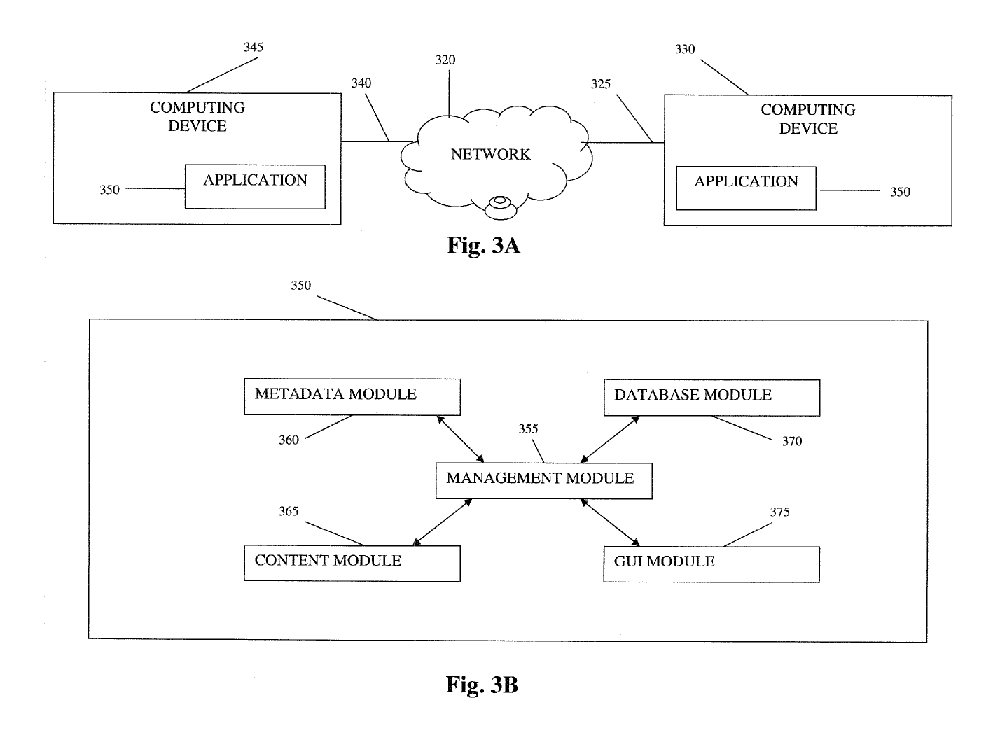

Reference is made to FIG. 3A showing a schematic high level diagram of exemplary components according to embodiments of the invention. Computing devices 330 and 345 may any applicable computing device or computer as described above. Network 320 may be similar to network 120 as described with reference to FIG. 1 and communication mediums 325 and 340 may be similar to communication mediums 125 and 140 as described with reference to FIG. 1. According to embodiments of the invention, application 350 may enable various operations, functionalities or aspects pertaining to a content space. For example, viewing of a content space, synchronization and/or distribution of content and/or metadata between devices and/or any applicable manipulations, operations or functionalities pertaining to content, metadata or any other associated information. According to embodiments of the invention, application 350 may be configured to only be active when specific users are logged onto a hosting computing device. Alternatively, application 350 may be configured to function when ever the hosting computing device is active and/or functional with regards to various aspects. For example, application 350 may be configured to run as a system service.

Reference is made to FIG. 3B showing an exemplary high level diagram of exemplary modules comprising application 350. According to embodiments of the invention, modules 355, 360, 365, 370 and 375 may be or may comprise software modules, hardware modules, firmware modules or any combinations of the preceding. According to embodiments of the invention, database module 370 may comprise any applicable information repositories. For example, module 370 may comprise, or be associated with, files, lists or any other applicable information structures and/or repositories. According to embodiments of the invention, information maintained by module 370 may further comprise of cross reference parameters and/or indexing information. Such reference and/or index parameters and/or information may enable associating content objects with their respective metadata objects, content spaces with their respective users and/or content objects and/or metadata objects or any other applicable and/or required associations.

According to embodiments of the invention, database module 370 may further comprise an information management sub-system. Such sub-system may coordinate, schedule, arbitrate, supervise or otherwise manage tasks, functionalities, aspects and/or operations pertaining to information maintained by module 370 and possibly used by modules comprising application 350 or other entities. For example, such tasks or aspects may be, storage of information in an information repository, retrieval of information from an information repository or maintaining information integrity in an information repository. Other tasks may be coordinating or arbitrating access to information. For example, a scenario whereby two or more entities attempt to access an information repository may require arbitration in order to maintain information integrity and coherency.

According to embodiments of the invention, database module 370 may be a third party database application such as any suitable, possibly commercial, database application. It should be noted that any database or other application or module capable of performing applicable tasks required by to embodiments of the invention may be used without departing from the scope of the present invention. According to embodiments of the invention, database module 370 may enable modules comprising application 350 to issue queries to a database and receive results and/or responses and/or perform tasks such as, but not limited to store information in a database, retrieve information from a database, or search and/or modify information in a data repository.

According to embodiments of the invention, graphical user interface (GUI) module 375 may enable a user to interact with to embodiments of the invention. For example, GUI module 375 may provide a user with a graphical view of a content space using the relevant metadata. According to embodiments of the invention, GUI module 375 may further enable a user to manipulate various properties, attributes or aspects of a content space and/or content or information objects, also using the relevant metadata. For example, GUI module 375 may enable a user to add and/or remove content objects to and from a content space respectively by interacting with the metadata associated with content items. For example, a user may select specific content or information objects to be included or contained in one or more content spaces by, for example, dragging a graphical representation of content objects such as thumbnail images or other icons, and dropping them in an appropriate location. According to embodiments of the invention, module 375 may further enable a user to modify the content of a content space. Exemplary operations or interactions that may be enabled by module 375 may be changing attributes of content or metadata objects. For example, module 375 may enable a user to rate content objects, share content or information objects with other users, add content objects to a content space, remove content or information objects from a content space or delete content objects from one or more associated storage devices. According to embodiments of the invention, module 375 may directly or indirectly interact with database module 370. For example, GUI module 375 may present information stored in database 370 to a user. For example, GUI module 375 may retrieve a list of content objects included in a specific content space from database module 370 and may further graphically present such list to a user.

It will be recognized that the graphical user interface described above is merely an example of an interface for a user to manipulate the content objects and metadata, and that embodiments of the present invention are not limited in this respect. For example, an application protocol interface (API) may be provided in which a computer may perform any of the above manipulations of the content objects and metadata. One example of such an API is a content space management application as described below, which may transfer content objects between devices, for example, based on weights of various computing devices, storage devices, parameters of content objects, etc. In such cases, there need not be a graphical user interface to enable the content object manipulations, but this may be performed automatically by the application.

According to embodiments of the invention, metadata module 360 may coordinate, schedule, arbitrate, supervise or otherwise manage tasks, functionalities, aspects and/or operations pertaining to metadata objects. According to embodiments of the invention, metadata module 360 may maintain coherency or consistency of a set of metadata objects among a number of devices. For example, if computing devices 330 and 345 are configured to enable a particular user to view or otherwise interact with a specific content space and a metadata object associated with a content object included in such content space is modified on computing device 330 then metadata module 360 on computing device 330 may automatically communicate the modified metadata object to computing device 345. Alternatively, in the example above, metadata module 360 on computing device 330 may inform computing device 345 that a metadata object has been modified. Accordingly, computing device 345, possibly utilizing the local metadata module 360, may retrieve the modified metadata object. According to other to embodiments of the invention, metadata module 360 may periodically check relevant devices for changes and/or modifications pertaining to metadata objects. For example, metadata module 360 may maintain a list, for example, in database module 370, of computing devices configured to enable interaction with one or more content spaces or content objects that are further configured to be viewed or otherwise interacted with by a user operating the local device. According to embodiments of the invention, module 360 may periodically check with devices in such list for changes, alterations and/or modifications to metadata objects.

According to embodiments of the invention, a content space, a specific content object or a number of specific content or information objects may be shared. For example, a user owning a content object may add such content object to a content space and may further share such object with a number of other users. According to embodiments of the invention, a user may use GUI module 375 to share an object. For example, GUI module 375 may provide a user with a drag-and-drop or other schemes whereby content objects or content spaces may be shared. According to embodiments of the invention, metadata module 360 on the device used for sharing content objects may communicate metadata objects to other, possibly remote, computing devices, consequently enabling users operating such remote computing devices to share such content objects. For example, a user operating computing device 330 may share a content object stored on computing device 330 with a user operating computing device 345. According to embodiments of the invention, metadata module 360 on computing device 330 may communicate a metadata object associated with the shared content object from computing device 330 to computing device 345. Accordingly, a user operating GUI module 375 on computing device 345 may be presented with a view of the shared content object. It should be noted that, according to embodiments of the invention, a metadata object may be communicated to a computing device while the content object associated with such metadata object may not be communicated. According to embodiments of the invention, metadata object may provide a view of content objects without necessarily providing an ability to consume such content objects.

According to embodiments of the invention, content module 365 may coordinate, schedule, arbitrate, supervise or otherwise manage tasks, functionalities, aspects and/or operations pertaining to content distribution and communication. For example, content module 365 may supervise or perform a process of transferring content objects from one computing device to another. For example, a user may realize that a specific content object has been added to, or is included in, a content space. For example by being presented with information contained in an associated metadata object. Such user may further wish to consume such content object. In such case, if the content object is not locally available, the content object may be required to be transferred to the user's computing device from the computing device storing the content object, such transfer may be performed or supervised by content module 365.

According to embodiments of the invention, various algorithms, policies and/or configurations may be employed, observed, consulted or otherwise taken into account by content module 365 in its capacity as a content distribution manager. For example, computing devices may be assigned weights or scores. According to embodiments of the invention, a weight or score may be assigned by a number of operational, functional and/or other attributes, properties, parameters or aspects pertaining to a computing device. Exemplary such attributes, parameters, properties or aspects may be a storage capacity and/or type, a computing capacity, a type of central processing units (CPU), a number of central processing units, attributes pertaining to a connection to a network such as a speed of a connection, a reliability of a connection, a duration of the day when a computing device is connected to a network (online), accessibility of a user to the computing device or the relative amount of time a user interacts with a computing device compared to the time of interaction with other computing devices associated with the user. According to embodiments of the invention, weights or scores may further be assigned to devices by a user. It will be realized that any parameters, information or aspects may be used for assigning weights and/or scores to computing devices without departing from the scope of the present invention.

It will further be noted that embodiments of the present invention may transfer a content object from one device to a plurality of recipient devices, whether the recipient devices are all a single user, for example, the sender of the content object, or associated with different users, for example, a friends group. Moreover, by sending a content object from one device to a plurality of devices, further advantages may be obtained. In some embodiments of the invention, the sending device may notify recipient devices of the identity and, for example, addresses of other recipient devices. Accordingly, recipient devices may obtain the content objects from the sender device, as well as from other recipient devices. For example, a first portion of a large file may be sent to a first recipient, and a second portion of the large file may be sent to a second recipient. The first recipient may then obtain the second portion directly from the second recipient, and the second recipient may then obtain the first portion directly from the first recipient, thereby allowing the sender device to send the large file only once.

According to embodiments of the invention, content distribution may be according to scores or weights assigned to devices. For example, computing device 345 may be a personal digital assistant or digital camera with limited storage capacity, limited processing power and limited display capabilities while computing device 330 may be a powerful computer with large storage capacity. Accordingly, under such conditions, computing device 345 may be assigned a low weight while computing device 330 may be assigned a high weight. According to embodiments of the invention, content such as pictures may be automatically transferred from a low weight device to a high weight device, for example, from computing device 345 to computer 330. According to embodiments of the invention, metadata pertaining to the acquired pictures may be created, for example, by metadata module 360 on computing device 345. According to embodiments of the invention, content module 365 may determine that due to the high weight assigned to device 330 and the low weight assigned to computing device 345 the pictures may be transferred to computing device 330. According to embodiments of the invention, possibly due to storage capacity constraints associated with computing device 345 content module 365 on computing device 345 may optionally delete the pictures from a storage of computing device 345. Such deletion may be performed after it has been confirmed that the pictures have been successfully stored on computing device 330. Such confirmation may be provided by content module 365 on computing device 330.

According to embodiments of the invention, content module 365 or other components may elect to store content in, or transfer content to, a computing device best capable of distributing the content, for example, a device that is connected to a network most of the time, or a device with the fastest link to a network. Alternatively, content may be transferred to the device best suited for presenting and/or providing the content. For example, multimedia content stored on a device incapable of producing audible effects, e.g., a device that is not fitted with speakers may be transferred to an alternative device better equipped to present and/or provide the content. As will be described below, content module 365 may be one of a number of components that may determine the storage location of content.

According to some embodiments of the invention, weights may be content specific. For example, a first device may be assigned a high weight with regard to a first type of content and a low weight with regard to a second content or information type. For example, device 345 may be equipped with a very powerful, high resolution display system but may further lack a capability to produce sound or audible effects. Accordingly, such computing device 345 may be assigned a high weight with regard to content such as pictures but a low weight with regard to content such as MP3. Accordingly, pictures uploaded to such computing device may be left in the computing device's storage while MP3 music content, if downloaded or otherwise transferred to such computing device may be transferred to a better suited computing device for storage.

According to embodiments of the invention, management module 355 may coordinate, schedule, arbitrate, supervise or otherwise manage tasks, functionalities, aspects and/or operations pertaining to the performance of application 350. For example, management module 345 may cause modules such as metadata module 360 and/or content module 365 to act when a network connection is restored. Another example may be causing GUI module 375 to re-read information from database module 370 after database 370 has been updated, thus providing a user with an up to date view of a content spaces or other aspects of the system. According to embodiments of the invention, management module 355 may perform additional tasks such as scheduling of tasks to be performed, inter communication between various modules comprising application 350, and events handling. For example, events handled by management module 355 may be a network connection status change, e.g., a network connection lost or restored, a detection of a remote, possibly associated computing device, e.g., detecting a network presence of a computing device associated with a user associated with the local device, a modification of a content space, etc.

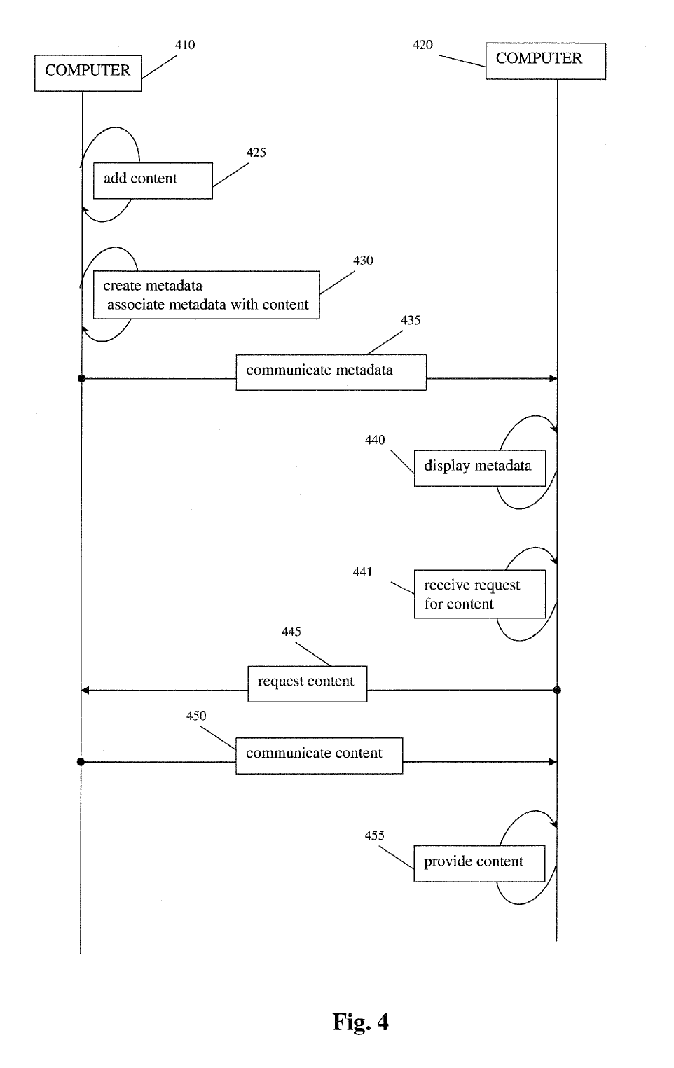

Reference is made to FIG. 4 showing an exemplary time-event flow chart according to embodiments of the invention. Computers 410 and 420 in FIG. 4 may be a computer as described above. According to embodiments of the invention and as shown by block 425, the flow may include adding content to a content space. For example, a user may upload pictures from a digital camera to computer 410 or a user may create a new document and further store such document in a folder included in a content space. For example, pictures or other content may be uploaded into a folder included in a content space. As described above, adding content to a folder included in content space may cause such content to be included in the content space. Alternatively, a user may select an existing content object stored on computer 410 and further select to include the selected content object in a content space.

According to embodiments of the invention and as shown by block 430, the flow may include creating metadata objects and further associating such metadata objects with the content objects added as described above. According to embodiments of the invention and as shown by block 435, the flow may include communicating metadata objects to computer 420. According to embodiments of the invention, changes to a content space may be propagated to sum or all devices associated with the content space. For example, if a user associated with a content space is further associated with computers 410 and 420 then changes applied to the content space on computer 410 may be propagated to computer 420. According to embodiments of the invention, a management module 355 on computer 410 may periodically communicate with management module 355 on computer 420. According to embodiments of the invention, such communication may comprise comparing and exchanging information or otherwise maintaining coherency of various aspects of a content space. For example, metadata objects may be communicated as depicted by block 435.

According to embodiments of the invention and as shown by block 440, the flow may include displaying metadata of contents in the content space to a user. For example, a user operating computer 420 may view a display of content space shared by computer 410 and computer 420. For example, GUI module 375 may present to a user operating computer 420 various information extracted from a metadata object associated with the content object added as shown by block 425. Accordingly, a user operating computer 420 may view that a new content object has been added to a content space as shown by block 425. According to embodiments of the invention and as shown by block 441, the flow may include receiving a request for a content object. For example, the content object added as shown by block 425 may be an MP3 music object, having viewed that such object has been added to a content space as shown by block 440, a user operating computer 420 may wish to listen to the music contained in such object. Accordingly, possibly by an action such as double clicking an icon presented by GUI module 375, a user may request the content object. The request may be user-generated or computer-generated.

According to embodiments of the invention and as shown by block 445, the flow may include a request for content. For example, an event detected by GUI module 375, may be communicated to content module 365, possibly through management module 355. According to embodiments of the invention, if the requested content object is not available locally, content module 365 may determine a computing device where the content object may be stored, for example by retrieving such information from database module 370 and may further issue a request for the content object to the device storing the content object.

According to embodiments of the invention and as shown by block 450, the flow may include communicating the content object. According to embodiments of the invention, the device communicating and/or providing the content as shown by block 450 may verify that the requesting device is indeed authorized to be provided with the content object. For example, a request for a content object may be required to include a parameter that may only be obtained from an associated metadata object thus ensuring that only computers that were previously provided with an associated metadata object, possibly as part of a content space sharing will further be provided with content as shown by bock 450. According to embodiments of the invention and as shown by block 455, the flow may include providing the content to a user or application. According to embodiments of the invention, providing the content as shown by block 455 may be performed by invoking any applicable application or program, possibly associated with the content type. For example, an MP3 player application may be invoked and further provided with the content object.

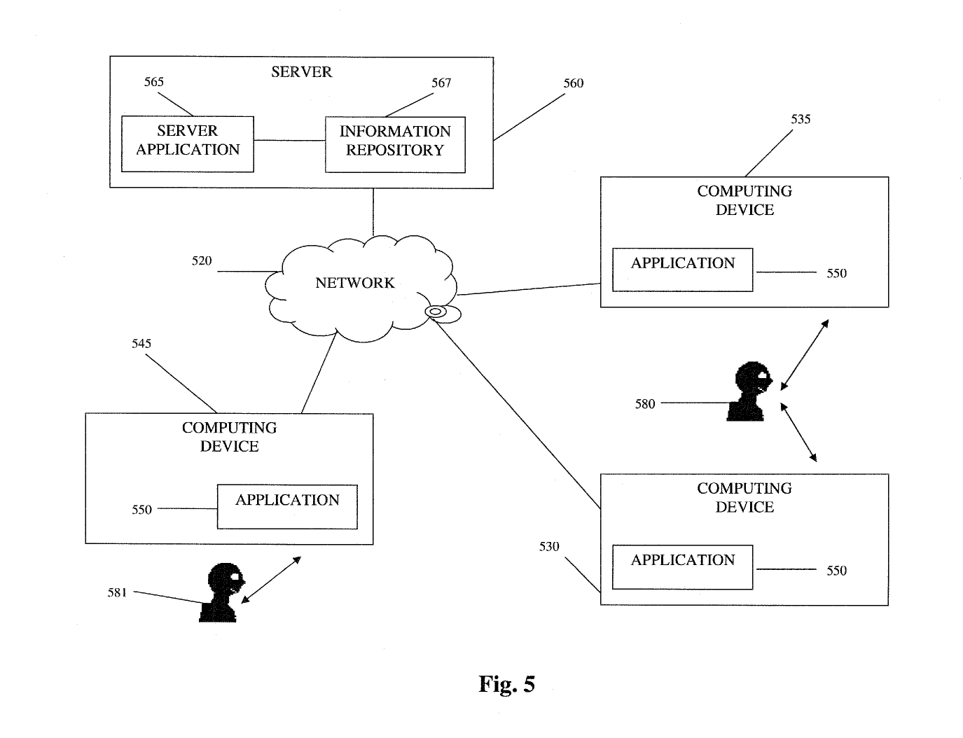

Reference is made to FIG. 5 showing an exemplary high level diagram of an exemplary system according to embodiments of the invention. Computing devices 530, 535 and 545 may be a computing device as described above. It will be recognized that according to embodiments of the invention, a configuration or setup as depicted in FIG. 5 may comprise of any number of computing devices such as computing devices 545, 530 and 535. Network 520 may be similar to network 120 as described with reference to FIG. 1, and applications 550 may be similar to application 350 as described with reference to FIG. 3A and FIG. 3B. Server 560 may be a computing device as described above. It will be recognized that according to embodiments of the invention, a configuration or setup as depicted in FIG. 5 may comprise of any number of servers such as server 560. According to embodiments of the invention, server application 565 may be or may comprise software modules, hardware modules, firmware modules and/or any combinations of the preceding. User 580 may own, operate or be otherwise associated with computing devices 530 and 535 and user 581 may own, operate or be otherwise associated with computing device 545. It will be recognized that according to embodiments of the invention, a configuration or setup as depicted in FIG. 5 may comprise of any number of users such as users 580 and 581.

According to embodiments of the invention, server application 565 may comprise one or more information repositories 567. For example, information repository 567 may comprise files, lists or any other applicable information structures, databases and/or repositories. According to embodiments of the invention, information maintained application 565 and possibly stored in information repository 567 may comprise of cross reference parameters and/or indexing information. Such references, index parameters and/or information may enable associating one or more content spaces with one or more respective users and/or computing devices. For example, a cross reference list or other data structure may enable server application 565 to locate and/or determine sum or all devices associated with a specific user, for example, using a user identification parameter devices associated with such user may be located in information repository 567. According to embodiments of the invention, information repository 567.

According to embodiments of the invention, server application 565 may further posses, store or be able to access information and/or parameters pertaining to a number of computing devices. For example, such information may include various attributes, properties and/or any other aspects such as, but not limited to, a computing capacity of a computing device, a display capacity of a computing device, a storage capacity of a computing device, a communication capacity of a computing device, any applicable content and/or information presentation capacities and/or any applicable resources available to a computing device. Additional, possibly transient information pertaining to devices that may be stored in information repository 567 may be parameters such as a current IP address, the number and identifying parameters of users currently logged onto a device etc.

According to embodiments of the invention, server application 565 may further posses, store, be able to access or otherwise obtain, possibly from information repository 567 information and/or parameters pertaining to entities such as content spaces, users, content objects and/or metadata objects. For example, an association between a content space and relevant computing devices may be stored in information repository 567. For example, server application 565 may be able to obtain, store and/or otherwise maintain information and/or parameters such as described above pertaining to computing devices 530, 535 and 545, users 580 and 581 and/or associated content spaces, content objects and metadata objects.

According to embodiments of the invention, server application 565 may provide, possibly upon request, information and/or parameters such as described above and/or any other applicable information. For example, server application 565 may communicate with applications 550 on computing devices 530, 535 and/or 545 and further exchange or communicate information pertaining to various computing devices, users, content spaces, content objects and/or metadata objects. For example, possibly upon a reset, application 550 on device 535 may communicate with server application 565. According to embodiments of the invention, server application may provide application 550 on device 535 with information and/or parameters such as an IP address that may enable application 550 on device 535 to exchange information with application 550 on device 530. For example, as described above, devices 535 and 530 may be associated with a common content space. Accordingly, upon reset, application 550 on device 535 may communicate with application 550 on device 530 and verify that such common content space is identically represented on both devices.

According to embodiments of the invention, user 580 may create a content space. For example, user 580 may utilize GUI module 375 to create the content space. According to embodiments of the invention, user 580 may name the content space and may further add content objects to the content space. For example, GUI module 375 may provide a graphical interface for adding content objects to a content space. According to embodiments of the invention, when a content object is added to, or associated with a content space, information reflecting such association may be stored in database module 370. For example, GUI module 375 may communicate information and/or parameters reflecting the addition or association of a content object to a content space. According to embodiments of the invention, a metadata object may be created for each content object added to a content space. For example, metadata module 360 may create such metadata objects and may further update database module 370 with information pertaining to the created metadata objects, possibly indicating the relevant content object. For example, after adding a content object to a content space, GUI module 375 may provide an indication pertaining to such event to metadata module 360 or GUI module 375 may provide such indication to management module 355, in such case, management module 355 may cause metadata module 360 to act accordingly, e.g., create a metadata object associated with the content object added to the content space.

According to embodiments of the invention, a content object may be added to a content space as a result of being associated with another content object. For example, if a folder is added to a content space then all content objects, e.g., files, contained in such folder may be added to the content space. Accordingly, if a new content object is added to such folder then such newly added content object may also be shared. For example, pictures uploaded from a digital camera to a folder included in a content space may thus be included in the content space. If such folder is further included in a shared content space then such pictures may further be shared by being placed in such shared folder.

According to embodiments of the invention, a user may be associated with a number of computing devices. For example, user 580 may be associated with computing devices 530 and 535 as shown in FIG. 5. According to embodiments of the invention, management module 355 may be configured to communicate with server 560. For example, management module 355 may be provided with a name and a domain of server 560 or with an internet protocol (IP) address of server 560 and/or any applicable parameters that may enable management module 355 to communicate with server 560. According to embodiments of the invention, management module 355 may provide server application 565 with information and/or parameters pertaining to its hosting computing device.

For example, management module 355 may provide sever application 565 with an IP address of its hosting computing device as well as any other information and/or parameters pertaining to operational, functional and/or other attributes, properties, parameters or aspects pertaining to the hosting computing device. For example, management module 355 may provide server application 565 with information and/or parameters pertaining to the hosting device such as, storage capacity and/or type, a computing capacity, a capacity of a network connection, a reliability of a network connection, a duration of the day when the hosting computing device is connected to a network (online), and/or any applicable parameters and/or information. It should be noted that any information that may be gathered, collected or otherwise obtained by any software module, firmware module, hardware module or a combination of the preceding may be so obtained by to embodiments of the invention and farther be communicated to server application 565 without departing from the scope of the present invention.

According to embodiments of the invention, sever application 565 may provide application 550 with various information. For example, server application 565 may provide application 550 with information pertaining to other computing devices associated with a user associated with a local computing device. For example, server application 565 may provide application 550 on computing device 530 with information and/or parameters pertaining to computing device 535. According to embodiments of the invention, sever application 565 may store, or otherwise maintain information pertaining to a number of computing devices. According to embodiments of the invention, sever application 565 may further be capable of associating a number of computing devices with one or more users. Accordingly, server application 565 may provide application 550 with information and/or parameters pertaining to some or all computing devices associated with a specific user, for example, a user associated with the computing device hosting a specific application 550.

According to embodiments of the invention, a metadata object may be communicated to some or all computing devices associated with a specific user. For example, following an addition of a content object to a content space and the consequent creation of a metadata object as described above, the metadata object may be communicated to some or all the computing devices associated with the user who is associated the content space. For example, a metadata object created on computing device 530 as described above may be communicated to computing device 535. According to embodiments of the invention, information such as an IP address of computing device 535 may be provided to server application 565 as described above, according to embodiments of the invention, such information may further be provided to computing device 530 consequently enabling computing device 530 to communicate the metadata object to computing device 535. According to embodiments of the invention, such distribution of metadata objects may enable a visibility of a content space from any computing device associated with such content space. For example, the content space created by user 580 as described above may be viewed by user 580 from computing device 530 and/or computing device 535. According to embodiments of the invention, the views of a content space provided to a user by two or more devices may be according to metadata objects distributed as described above and consequently, such views may be identical.

According to embodiments of the invention, content objects associated with a content space may be distributed to a number of computing devices. For example, possibly in addition to distributing the metadata object as described above, a content object added to a content space as described above may be communicated to one or more computing devices associated with a user. It should be noted that while metadata object may be distributed to all devices associated with a specific user, possibly in order to enable a visibility of a content space from any one of such devices, the associated content may only be distributed to, and/or stored on, some of the associated devices. According to embodiments of the invention, distribution of content objects may be according to various constraints, information and/or parameters. For example, content distribution may be according to weights or scores described above.

According to embodiments of the invention, content module 365 may communicate content objects. For example, possibly following an addition of a content object to a content space as described above, content module 365 may be informed, for example, by management module 355 that a specific content object has been added to a specific content space. For example, user 580 may have selected a file, in a specific storage location on device 530 to add to a content space. According to embodiments of the invention, possibly after the file has been added to the content space, content module 365 may communicate the file to selected computing devices. For example, content module 365 may communicate the file from computing device 530 to device 535 since the two devices may be associated with user 580 according to the example above.

According to embodiments of the invention, content spaces may be shared. For example, possibly after creating a content space as described above and further populating such content space with content objects as described, user 580 may share such content space with user 581. According to embodiments of the invention, in order to share a content space a user identification may be required. A user identification may be a unique identification parameter such as an electronic mail address or any other applicable unique identifier. According to embodiments of the invention, user identifications may be associated with content spaces and may also be associated with computing devices. For example, some of the information stored and maintained by server application 565 may be such associations. Accordingly, user 580 may use a user identification provided by user 581 in order to share a content space with user 581.

According to embodiments of the invention, GUI module 375 may provide a user with a graphical interface for sharing a content space. For example, in order to share a content space with another user, a user may be required to navigate to an appropriate GUI window, enter an identification of the user with whom a content space is to be shared, select a content space to share and press an “APPLY” button. According to embodiments of the invention, management module 355 may communicate such provided user identification to server application 565. According to embodiments of the invention, upon receiving such user identification, server application 565 may extract from one or more of the information repositories described above a list of devices associated with the user corresponding to the user identification. Server application 355 may further provide such list to management module 355. According to embodiments of the invention, server application 565 may further provide management module 355 with additional information and/or parameters pertaining to such devices, for example, parameters as described above. For example, server application 565 may provide management module 355 with information required to establish communication with the devices associated with the user corresponding to the user identification, for example, an IP address may be provided.

According to embodiments of the invention, possibly upon being provided with information as described above, management module 355 may cause metadata module 360 to commence communicating metadata objects associated with the shared content space to devices associated with the user with whom the content space is shared. According to embodiments of the invention, rather than, or in addition to sharing a content space, a user may share specific content objects with other users. For example, user 580 may share a specific content object with user 581. According to embodiments of the invention, such sharing may be similar to sharing a content space where actions, procedures and flows described above with regard to a content space may pertain to a specific content object.

According to embodiments of the invention, content objects distribution may be according content spaces sharing. According to embodiments of the invention, possibly in addition to communicating metadata objects to devices sharing a content space as described above, content objects may be communicated to such devices. According to embodiments of the invention, such communication of content objects may be according to algorithms, policies and/or any other applicable considerations as described above. For example, following a sharing of a content space by user 580 with user 581, content objects stored on devices 530 and 535 may be communicated to device 545.

According to embodiments of the invention, various operation, functionalities and flows may be made possible by embodiments of the invention. For example, a flow may include creating a content space. According to embodiments of the invention, a user may create a content space by utilizing a GUI application such as GUI module 375. According to embodiments of the invention, a user may provide a name or any other applicable identification to be assigned to a content space. According to embodiments of the invention, a user creating or owning a content space may provide a list of users and may further indicate a level of interaction with the content space granted to each of such users. For example, a user creating a content space may provide a list of users, by for example, providing identification parameters of such users, and may further grant a “view” permission to some of those users, where a “view” permission may enable users to view, see, or be otherwise aware of which content objects are included in the content space but possibly disable such users from consuming such content objects. According to embodiments of the invention, a user may grant a “view and consume” permission to some users, where a “view and consume” permission may enable users to view which content objects are included in the content space and further consume such content objects. According to embodiments of the invention, a user may grant a “view, consume and modify” permission to some users where such permissions may enable users to view, consume and modify content included in the content space. According to embodiments of the invention, a modify permission may enable users to modify content as well as delete content from a content space. According to embodiments of the invention, any combination of applicable permission levels such as described above or other may be supported without departing from the scope of the invention. According to embodiments of the invention, information and/or parameters required to support permissions as described above may be embedded in metadata objects and/or database module 370.

According to embodiments of the invention, a flow may include detecting an interaction with a content space. For example, a user utilizing GUI module 375 may cause an event that may be detected. For example, adding a content object to a content space or removing a content object from a content space. Some exemplary events according to embodiments of the invention are described below. According to embodiments of the invention, a detected event may be or may comprise content consumption. For example, a user may select a content object, possibly located by viewing the content space, for consumption. For example, having located an MP3 content object a user may further opt to listen to the music contained in such MP3 object.

According to embodiments of the invention, a consumption flow may include obtaining a content object from a storage location. According to embodiments of the invention, a user may be presented with a view of a content space and may further be able to select a content object for consumption even if or when the content object is not locally available. As described above, such view and selection for consumption may be made possible by utilizing metadata objects representing content objects. Accordingly, when a user or application so permitted, selects a content object for consumption and the content object is not readily available, e.g., stored locally, the content object may be transferred from an alternative storage and further provided to a user or application. For example, user 580 in FIG. 5 may select to consume a content object by interacting with a content space from computing device 530. According to embodiments of the invention, although a metadata object representing the content object may be stored and available on computing device 530 the associated content object may not. For example, the content object may be stored on computing device 535 that may also be associated with user 580 and the relevant content space. Accordingly, upon opting to consume the content object on device 530, the content object may be communicated from device 535 to device 530 and further provided to user 580 for consumption.

According to embodiments of the invention, the content object may be provided to a user or application for consumption. According to embodiments of the invention, a content obtained from a remote computing device may be first stored locally and then provided to a user or application or it may be provided to a user or application directly from a network, possibly at the rate received. According to embodiments of the invention, a flow may include modifying one or more metadata objects. According to embodiments of the invention, a metadata object may be modified directly or indirectly by a user or application. An example of indirect modification of a metadata object may be a changing of a size of an associated content object. According to embodiments of the invention, a metadata object may contain parameters and/or information pertaining to various attributes of an associated content object. For example, object size, object storage location, object creation and/or modification date etc. Such parameters and/or information contained in a metadata object may be modified indirectly by a user or application by modifying the associated content object.

According to embodiments of the invention, parameters and/or information included in a metadata objects may be kept consistent with their respective content object. For example, when a content object included in a content space and further associated with a metadata object is modified then such event may be detected and appropriate modifications may be made to the associated metadata object. For example, management module 355 may be configured to detect an access to a file system where content objects are stored. Accordingly, management module 355 may detect, or be informed of, access to content objects and may further cause metadata module 360 to apply required, desirable or otherwise applicable changes to metadata objects when their associated content objects are modified.

According to embodiments of the invention, a metadata object may be modified even if the associated content object is not modified, and possibly on a device where the associated content object is not stored, or otherwise present or available. According to embodiments of the invention, a metadata object may include information and/or parameters such as a user rating, e.g., whether the associated content is included in a favorites list, the number of times the associated content object has been consumed, the last time the associated content object has been consumed, whether the associated content object is shared etc. According to embodiments of the invention, such parameters, information and metadata may be modified without otherwise effecting the associated content object. For example, a user may choose to include a content object in a favorite or starred content objects list, information reflecting such choice may be stored in a metadata object without modifying, or even accessing the associated content object.

According to embodiments of the invention, a flow may include updating local information. For example, including a content object in a starred list or group may comprise modifying the associated metadata as described above and may further comprise updating a list of starred object. For example, such list may be stored and/or maintained by database module 370 described above. According to embodiments of the invention, a flow may include updating remote devices. In the example above, including a content object in a starred list of objects may be reflected in a view of the content space. As described above, a content space view may be kept consistent or the same when presented from a number of devices associated with the content space. Accordingly, modifications to metadata objects may be propagated to some or all devices associated with the relevant content space. Consequently, a consistent or otherwise same view of a content space may be presented by a plurality of devices.

According to embodiments of the invention, a flow may include modifying content, e.g., a content or information object. According to embodiments of the invention and as described above, management module 355 may detect an access to a content object. According to embodiments of the invention, when a content object is modified its associated metadata object may be modified. For example, if the size of a content object is changed, for example, a number of text lines are deleted from a document, then in some embodiments of the invention, associated metadata objects may be modified accordingly to reflect the changes applied to the associated content object. According to some embodiments of the invention, when a content object is modified, the modified content object may be stored as a separate content object and the integrity of the original content object retained. In this case, the metadata of the original content object may also be unchanged. The modified content object may have a new metadata object pertaining to the modified content object, which may reflect an association or derivation from the original content object.

According to embodiments of the invention a content object may be associated with a number of metadata objects. According to embodiments of the invention, a computing device storing a specific content object may further have a number of content spaces defined and/or otherwise associated with it. Accordingly, if a specific content object is modified then some or all associated metadata object may be modified in order to reflect the changes in their respective content spaces views. According to embodiments of the invention local information, possibly stored by database module 370 may be updated to reflect changes to the content. According to embodiments of the invention, a change or modification applied to a content object may be propagated to other devices. For example, the modified content object may be copied to a number of devices sharing the content space with which the modified content object is associated. According to embodiments of the invention, the modified content object communicated as described above may replace an existing, possibly older version on some of the devices to which it is communicated.

According to embodiments of the invention, the flow may include removing a content object from a content space. According to embodiments of the invention, removing a content object from a content space does not necessarily include removing such content object from storage on the relevant device. According to embodiments of the invention, removing a content object from a content space may comprise deleting associated metadata objects and further removing or otherwise updating associated entries in one or more local data or information repositories. For example, removing a content object from a content space may comprise deleting its associated metadata object and further removing references to the content objects from various lists, e.g., a favorite list, a music list or library or any other applicable information structures. According to embodiments of the invention, removing a content object from a content space may comprise updating remote devices of such event. For example, metadata objects associated with the content object stored on other devices may be deleted in order to reflect the new configuration where by the content object is no longer included in the content space.

According to embodiments of the invention and as described above, copies of the content object may be stored on a number of devices associated with a content space. According to embodiments of the invention, when a content object is removed from a content space then copies of such content object that were stored on devices in order to enable or accelerate consumption of content included in a content space may be deleted. According to embodiments of the invention, if a content object was stored on a computing device as a result of content space content distribution and/or content consumption enablement or acceleration then such content object may be removed from such device if the content object is removed from the content space. According to embodiments of the invention, database module 370 may maintain information that may enable embodiments of the invention to determine if a specific content object should be removed from storage when it is removed from a content space.

According to embodiments of the invention and as described above, a content object may be included in a number of content spaces. Accordingly, such content object may only be removed from storage if it is not included in any content space associated with the device. According to embodiments of the invention, removing of a content object from storage as a result of its being removed from a content space may be configurable, namely, embodiments of the invention may leave or remove a copy of a content object removed from a content space according to a configuration parameter, possibly provided by a creator and/or owner of the content space. Such configuration parameters may be stored in database module 370. According to embodiments of the invention, upon a removal of a content object from a content space, management module 355 may cause content module 365 to extract information pertaining to the content object removed from database module 370 and further determine if the content object should be removed from local storage.

For example, as a result of user 581 sharing a content space with user 580, a specific content object, included in the shared content space, may be copied from computing device 545 to computing device 535. Such content object may further be stored on a storage device attached to computing device 535. According to embodiments of the invention, if user 581 removes such content object from the shared content space then the copy stored on device 535 may be deleted. According to embodiments of the invention, user 581 may provide or apply configuration parameters to override such behavior and cause embodiments of the invention to leave a copy of a content object removed from a content space as described above.

According to embodiments of the invention, a flow may include adding a content object to a content space. According to embodiments of the invention, a user may select any applicable content from a local storage device or any other applicable storage device to be included in a content space. For example, content objects added to a content space may be hypertext or hypermedia documents links, text documents, multimedia content and/or any applicable digital information. According to embodiments of the invention, content added to a content space may be stored on a plurality of, possibly geographically distant storage devices. For example a content space may comprise of content stored on a user's computing device, a user's mobile phone and an internet site. As described above, availability of content included in a content space may sometimes lag behind a view of the content space. For example, a content object included in a content space may be stored on an internet site. Such content object may be visible on a number of computing devices even when such devices are not connected to the internet. A user wishing to consume such visible content object may be required to delay such consumption until the relevant computing device is operatively connected to the internet or is otherwise able to communicate with the internet site.

According to embodiments of the invention, a flow may include creating metadata objects. According to embodiments of the invention, adding a content object to a content space may comprise creating a metadata object and further associating the metadata object with the content object. According to embodiments of the invention, metadata object may be used to represent the content object in the content space. According to embodiments of the invention, adding a content object to a content space may include updating local information, for example, information maintained by database module 370 may be updated or stored in order to reflect an addition of a content object to a content space. According to embodiments of the invention, adding a content object to a content space may further include updating remote devices. For example, a metadata object created and associated with a content object added to a content space may be communicated to some or all devices associated with the content space. For example, management module 355 may obtain a list of all devices associated with the content space to which the content object was added. According to embodiments of the invention, management module 355 may further obtain information indicating which of such devices is currently online or otherwise accessible. Such information may be obtained from server application 565.

According to embodiments of the invention, management module 355 may further cause metadata module 360 to communicate metadata objects created and associated with content objects added to the content space to all accessible devices. According to embodiments of the invention, management module 355 may further cause content module 365 to communicate, possibly according to various policies, algorithms and/or any other applicable considerations, the content object added to the content space to some or all devices associated with the content space. According to embodiments of the invention, management module 355 or content module 365 may schedule a future communication of metadata objects and/or content objects to devices that are inaccessible at the time the content object is added to a content space.

According to embodiments of the invention, a content object added to a content space may be associated with a unique, possibly secret identification parameter. According to embodiments of the invention, communicating a content object by embodiments of the invention may comprise attaching such identification parameter. Such configuration or paradigm may prevent malicious, erroneous and/or stray users or applications from manipulating content objects associated with embodiments of the invention. For example, content module 365 may verify that received content objects are accompanied by a proper identification parameter. According to embodiments of the invention, secured communication, e.g., secured socket layer (SSL), may be employed in order to maintain data security and integrity. It will be recognized that any applicable, possibly commercial, scheme, paradigm, configuration or setup for maintaining data security and/or integrity may be employed without departing from the scope of the invention.

According to embodiments of the invention, a flow may include sharing a content object or content space. According to embodiments of the invention, a user may share a content space or a specific content object. According to embodiments of the invention, sharing a content space or content object may comprise obtaining parameters. For example, management module 355 may obtain information pertaining to the user with whom a content space or object is being shared. For example, such information may be a list of computing devices associated with such user, information required in order to communicate with such devices, e.g., an IP address, and/or any other applicable information. According to embodiments of the invention, management module 355 may obtain such information from server application 565.

According to embodiments of the invention, sharing a content object or a content space may include updating local information, for example, information maintained by database module 370 may be updated or stored in order to reflect a sharing of a content object or a content space. According to embodiments of the invention, sharing a content object or a content space may include updating remote devices. For example, a metadata objects associated with a shared content object or a shared content space may be communicated to some or all devices associated with the content space.

According to embodiments of the invention, after sharing content with one or more users or devices, a user may opt to discontinue a sharing of some of previously shared content. According to embodiments of the invention, a user may select one or more shared content objects or content spaces that may no longer be shared with one or more users or devices. According to embodiments of the invention, such discontinuing of sharing may cause embodiments of the invention to remove relevant metadata objects from a storage on devices associated with the discontinued sharing. For example, user 580 may share a content space with user 581. User 580 may opt to discontinue such sharing and may further cause such sharing to be discontinued, for example by employing GUI module 375 to select the content space to no longer be shared with user 581. According to embodiments of the invention, metadata objects associated with the selected content space stored on computing device 545 may be removed. Consequently, the relevant space may no longer be visible by user 581 from device 545. As described above, possibly in addition to storing metadata objects on devices sharing a content object or space, content objects may be stored on the device. In the example above, content objects may be copied from computing device 530 or computing device 535 to device 545 and may further be stored on computing device 545.

According to embodiments of the invention, content objects that may have been stored on a device as a result of sharing may be removed when the sharing is discontinued. In the example above, content objects that may have been copied to, and stored on, device 545 as a result of, or in association with sharing may be removed from device 545 when such sharing is discontinued, for example, by user 580.

According to embodiments of the invention, a transaction log, list, record or any other applicable structure or entity may be maintained by application 350 and/or server application 565. According to embodiments of the invention, such log may serve a number of purposes. For example, transactions that may need to be delayed may be recorded in such log and may be executed at a later time or stage. Debugging and/or analyzing various operational or other aspects may utilize such records, logs or lists. According to embodiments of the invention, a transaction log entry may comprise information such as a unique identification of a content object, e.g. a secure hash algorithm (SHA) message digest, a destination computing device, time parameters and/or any applicable information or parameters.

According to embodiments of the invention, aspects such as coherency and consistency of content spaces views or other aspects may be continuously observed by embodiments of the invention. For example, a number of instances of application 550 may periodically communicate with one another and/or with server application 565. According to embodiments of the invention, such communications may comprise exchanging information such as scope, modifications, configurations and/or any other aspects pertaining to content objects, content spaces, computing and storage devices, users and/or any other applicable aspects or entities.

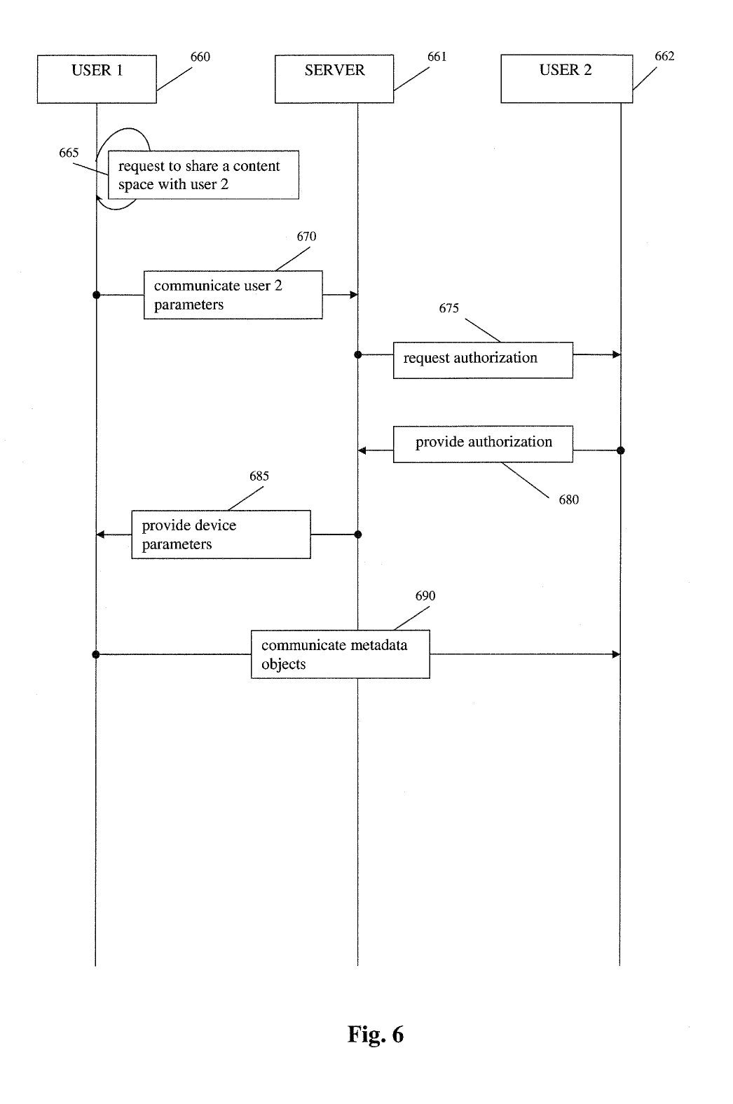

Reference is made to FIG. 6 showing an exemplary time-event flow chart according to embodiments of the invention. Server 661 may be a computer as described above and may further comprise components as described with reference to server 560 shown in FIG. 5. Users 660 and 661 may be operating two computers such as computing devices 330 or 345 capable of communicating over a communication network such as network 320. According to embodiments of the invention and as shown by block 665, the flow may include a request to share a content space. For example, user 660 may wish to share a content space with user 662. According to embodiments of the invention, user 660 may use GUI module 370 in order to select a content space or content object to share. According to embodiments of the invention, user 660 may further select one or more users with whom the content space or object is to be shared. According to embodiments of the invention and as shown by block 670, the flow may include communicating information and/or parameters pertaining to users to server 661. According to embodiments of the invention, such parameters may be a user identification parameter such as an electronic mail (email) address or any other parameter identifying a user.

According to embodiments of the invention, server 661 may store information and/or parameters associating users with devices. For example, server 661 may be capable of determining one or more devices associated with a user based on provided an identification parameter such as described above. According to embodiments of the invention and as described above, server 661 may further store or be otherwise capable of obtaining parameters and/or information pertaining to computing devices. For example, server 661 may store IP address of sum or all computing devices associated with some or all content spaces and/or users. Accordingly, server 661 may be capable of communicating with a computing device associated with user 662.

According to embodiments of the invention and as shown by block 675, the flow may include communicating, by server 661 a request for authorization to share a content space. According to embodiments of the invention, user 662 may be required to authorize a share of a content space as described above. For example, GUI module 375 may provide user 662 with a dialogue box informing user 662 that user 660 wishes to share a content space with him. According to embodiments of the invention, any additional text or other content may be communicated with such request and further presented, for example, to user 662 in the example above. According to embodiments of the invention and as shown by block 680, the flow may include communicating an authorization to share a content space, possibly provided by a user on the receiving computing device, e.g., user 662.

According to embodiments of the invention and as shown by block 685, the flow may include communicating information and/or parameters to a computing device associated with user 660. For example, if user 662 in the example above has authorized the share operation then server 661 may communicate to devices associated with user 660 parameters and/or information that may be required in order to establish a connection or session with devices associated with user 662. According to embodiments of the invention and as shown by block 690, the flow may include communicating metadata objects from a device associated with user 660 to one or more devices associated with user 662. Accordingly, as described above, the content space may be shared.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method of providing content comprising:
storing on a first storage device associated with a first computing device a plurality of metadata objects pertaining to a respective plurality of content objects, wherein a first portion of the content objects are stored on the first storage device, and a second portion of the content objects are stored on a second storage device associated with a second computing device;
receiving a request at the first computing device for a selected content object associated with a respective selected metadata object, the selected content object stored on the second storage device;
obtaining the selected content object from the second computing device; and
storing the selected content object on the first storage device.

2. The method of claim 1 further comprising:
after obtaining the selected content object, providing the selected content object on the first computing device for consumption by the user.

3. The method of claim 1, further comprising displaying on a display associated with the first computing device metadata objects pertaining to the second portion of the content objects.

4. The method of claim 1, wherein the request is provided by a user using an input device associated with the first computing device.

5. The method of claim 1, wherein the request is provided by an application executed on the first computing device.

6. The method of claim 5, further comprising:
generating the request based on at least one property of at least one of the first and second computing devices.

7. The method of claim 5, further comprising:
generating the request based on at least one property of at least one of the first and second storage devices.

8. The method of claim 5, further comprising:
generating the request based on at least one attribute of the selected content object.

9. The method of claim 1, wherein the first and second computing device are associated with a first user.

10. The method of claim 1, wherein the first computing device is associated with a first user and the second computing device is associated with a second user.

11. An apparatus for providing content comprising:
a computing device; and
a storage device associated with the computing device having stored thereon a plurality of metadata objects pertaining to a respective plurality of content objects, wherein a first portion of the content objects are stored on the storage device, and a second portion of the content objects are stored on a second storage device associated with a second computing device,
wherein the computing device has stored thereon a set of instructions that when executed result in:
receiving a request for a selected content object associated with a respective selected metadata object, the selected content object stored on the second storage device,
obtaining the selected content object from the second computing device, and
storing the selected content object on the first storage device.

12. The apparatus of claim 11, wherein after obtaining the selected content object, the set of instructions when executed further result in providing the selected content object on the first computing device for consumption by the user.

13. The apparatus of claim 11, wherein the set of instructions when executed further result in displaying on a display associated with the first computing device metadata objects pertaining to the second portion of the content objects.

14. The apparatus of claim 11, further comprising a user input device, wherein the request is provided by a user using the input device.

15. The apparatus of claim 11, wherein the set of instructions when executed further result in generating the request for the selected content object.

16. The apparatus of claim 15, wherein the set of instructions when executed further result in generating the request for the selected content object based on at least one property of at least one of the first and second computing devices.

17. The apparatus of claim 15, wherein the set of instructions when executed further result in generating the request based on at least one property of at least one of the first and second storage devices.

18. The apparatus of claim 15, wherein the set of instructions when executed further result in generating the request based on at least one attribute of the selected content object.

19. The apparatus of claim 11, wherein the first and second computing device are associated with a first user.

20. The apparatus of claim 11, wherein the first computing device is associated with a first user and the second computing device is associated with a second user.
